(19) United States
(12) Patent Application Publication
(10) Pub. No.: US 2025/0382818 A1
(43) Pub. Date: Dec. 18, 2025

(54) Solar panel gazebo or tent

(71) Applicant: Jungle Power Pty Ltd, Clayton Vic (AU)

(72) Inventor: QINGSI HU, NOTTING HILL VIC (AU)

(21) Appl. No.: 18/743,499

(22) Filed: Jun. 14, 2024

(51) Int. Cl. E04H 15/10; E04H 15/58; H02S 20/23

(52) U.S. Cl. CPC E04H 15/10; E04H 15/58; H02S 20/23

(57) ABSTRACT

A solar panel gazebo or tent including: a canopy structure including a plurality of sloping surfaces, a plurality of supporting poles supporting the canopy structure, at least one eave structure extending from a lower edge of one of the plurality of sloping surfaces; and at least one semi-flexible photovoltaic solar panel mounted on the canopy structure and/or the at least one eave structure; wherein the at least one semi-flexible photovoltaic solar panel is configured to collect solar energy.

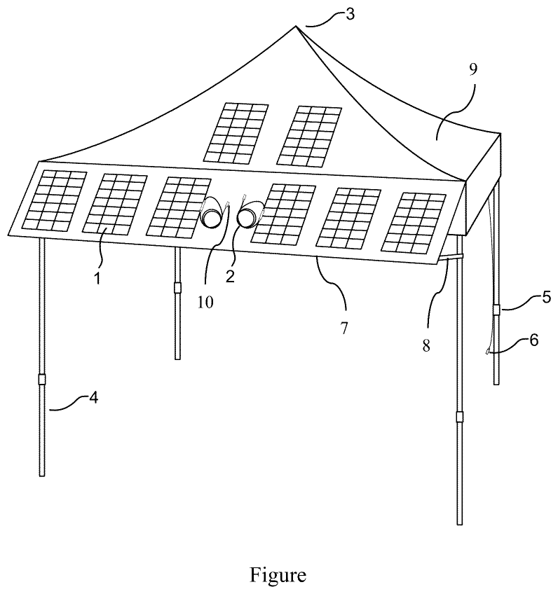

### TECHNICAL FIELD

The present disclosure relates to the technical field of gazebos or tents, and more specifically to a solar panel gazebo or tent.

### BACKGROUND

With the increasing popularity of outdoor activities, a resurgence of interest occurred in the camping industry. When people go for an outing, especially stay outside overnight, the power supply is needed. The solar energy is an ideal energy source. A variety of existing tents have been designed to collect solar energy.

However, most current outdoor gazebos and tents with integrated solar panels face several difficulties and problems. These include limited solar collection areas, complex installation and storage processes, the use of rigid and heavy solar panels, inadequate waterproofing, and insufficient structural support.

The existing outdoor gazebos or tents that incorporate solar panels usually have limited surface area for mounting the solar panels, which restricts the amount of solar energy that can be harvested.

Many existing systems use rigid solar panels that are prone to damage and less adaptable to varying shapes and surfaces. These panels are also heavier, adding to the overall weight of the structure. Hence, the existing outdoor gazebos and tents have complex installation and storage processes.

Many existing solar panel systems for outdoor shelters are difficult to install and dismantle, requiring significant time and effort. Some may also lack portability, making them cumbersome to store and transport.

Some existing outdoor solar solutions are not adequately waterproof, making them unsuitable for all-weather use. Water ingress can damage the solar panels and electrical components, reducing the longevity and reliability of the system.

In addition, the traditional solar-equipped gazebos or tents lack adequate structural support, especially when additional panels are added, making them unstable and unsafe in windy or harsh conditions.

These shortcomings make existing solutions less efficient, durable, and practical for regular outdoor use. Therefore, it would be desirable to provide a gazebo or tent that is able to significantly increase the surface area available for solar panels, simplify the structure of the tent or gazebo for ease of installation and dismantling, enhance durability and flexibility of solar panels, and ensure all-weather usability of the tent.

### SUMMARY OF THE DISCLOSURE

It is therefore an object of the present disclosure to provide an improved tent or gazebo as compared to the prior art, which increases the amount of solar energy harvested, simplifies the structure of the tent or gazebo for ease of installation and dismantling, enhances durability and flexibility of solar panels, ensures all-weather usability of the tent.

The present disclosure provides a solar panel gazebo or tent including: a canopy structure including a plurality of sloping surfaces, a plurality of supporting poles supporting the canopy structure, at least one eave structure extending from a lower edge of one of the plurality of sloping surfaces; and at least one semi-flexible photovoltaic solar panel mounted on the canopy structure and/or the at least one eave structure; wherein the at least one semi-flexible photovoltaic solar panel is configured to collect solar energy.

Optionally, the at least one eave structure is foldable.

Optionally, the at least one eave structure is provided with a supporting rod configured to adjust an inclination of the at least one eave structure, wherein one end of the supporting rod is connected to one supporting pole, and an other end of the supporting rod is connected to the at least one eave structure.

Optionally, a shape of the at least one semi-flexible photovoltaic solar panel is adaptable to contours of the canopy structure and the at least one eave structure.

Optionally, each supporting pole is provided with an adjustable mechanism configured to adjust a length of the supporting pole.

Optionally, each semi-flexible photovoltaic solar panel is connected to a power storage device by an electrical connector integrated with the semi-flexible photovoltaic solar panel and a wiring; the electrical connector and the wiring are waterproof.

Optionally, the plurality of supporting poles and the supporting rod are made of rust-resisting materials.

Optionally, each supporting pole comprises at least two pole sections connected by an adjustable joint.

Optionally, the gazebo or tent is modular, wherein the at least one eave structure and the pole sections are detachable.

Optionally, the gazebo or tent further comprises an integrated power storage system to store solar energy collected by the at least one semi-flexible photovoltaic solar panels.

Optionally, the electrical connector and the wiring comprise a quick-connect system to simplify setup and disassembly.

Optionally, the gazebo or tent further comprises sensors to detect wind speed and weather conditions, automatically adjusting the at least one eave structure and the at least one semi-flexible photovoltaic solar panel.

Optionally, the gazebo or tent further comprises an integrated lighting system powered by the collected solar energy.

Optionally, the gazebo or tent further comprises weighted bases or guy lines configured to increase stability of the gazebo or tent in windy conditions.

In the present disclosure, the solar panel gazebo or tent includes an eave structure extending from a lower edge of the sloping surface of the canopy structure, a plurality of supporting poles with an adjustable length and a semi-flexible photovoltaic solar panel mounted on the canopy structure and/or the at least one eave structure. The solution of the present disclosure achieves the following beneficial technical effects: (1) The amount of solar energy harvested is significantly increased. The solar panel gazebo or tent of the present disclosure includes the eave structure which can provide additional surface area for mounting solar panels, significantly increasing the solar collection capacity. (2) The structure of the tent or gazebo is simplified for ease of installation and dismantling. The canopy structure and eave structure are designed to be easily foldable and extendable, allowing for compact storage and quick setup. The gazebo or tent is designed for ease of installation and dismantling, ensuring that it can be set up and taken down quickly and without the need for specialized tools or expertise. It is highly portable and convenient for a wide range of outdoor activities, including camping, picnics, and outdoor events. (3) The durability and flexibility of solar panels is enhanced. By utilizing semi-flexible solar panels, the invention offers a durable and adaptable solution that can conform to various shapes and surfaces. These panels are less prone to damage compared to rigid panels and contribute to a lighter overall structure. (4) The all-weather usability of the solar panel gazebo or tent is ensured. The gazebo or tent is equipped with waterproof components, including the solar panels and electrical connectors. This ensures reliable performance in various weather conditions, making the tent suitable for year-round use. (5) the stable structure is provided. The disclosure provides stable supporting poles and adjustable mechanisms that enhance the stability of the gazebo or tent, even when additional solar panels are installed on the eave structure. This ensures the safety and reliability of the structure in windy or harsh conditions.

### BRIEF DESCRIPTION OF THE DRAWINGS

To illustrate the technical solutions of the embodiments of the present disclosure more clearly, the accompanying drawing of the embodiments will be briefly described below.

The solo figure is a structural schematic view of a solar panel gazebo or tent of the present disclosure.

### REFERENCE NUMERALS

| No. | Name | No. | Name | No. | Name |
|---|---|---|---|---|---|
| 1 | semi-flexible | 2 | electrical | 3 | canopy structure |
| | photovoltaic | | connector | | |
| | solar panel | | | | |
| 4 | supporting pole | 5 | adjustable | 6 | wiring |
| | | | mechanism | | |
| 7 | eave structure | 8 | supporting rod | 9 | sloping surface |
| 10 | quick-connect | | | | |
| | system | | | | |

The realization of the purpose, functional features, and advantages of the present disclosure will be further described in conjunction with the embodiments and with reference to the accompanying drawing.

### DETAILED DESCRIPTION

The technical solutions in the embodiments of the present disclosure will be described clearly and completely in the following in conjunction with the accompanying drawings in the embodiments of the present disclosure, and it is obvious that the described embodiments are only a part of the embodiments of the present disclosure and not all of the embodiments. Based on the embodiments in the present disclosure, all other embodiments obtained by those skilled in the art without creative labor fall within the scope of the present disclosure. In addition, the technical solutions between various embodiments can be combined with each other, but it must be based on the fact that those skilled in the art is able to realize it. When the combination of the technical solutions appears to be contradictory or unattainable, it should be considered that the combination of such technical solutions does not exist, and is not included in the scope claimed by the present disclosure.

It should be noted that when the embodiments of the present disclosure involve directional indications (such as up, down, left, right, forward, back . . . ), the directional indications are only intended to explain a relative positional relationship, a movement, etc. between the various components in a particular attitude. When the particular attitude changes, the directional indications are also changed accordingly.

In addition, when the embodiments of the present disclosure contain descriptions involving “first”, “second”, etc., the descriptions of “first”, “second”, etc. are intended only for descriptive purposes, and are not to be construed as indicating or implying their relative importance or implicitly specifying the number of the indicated technical features. That is, a feature defined as “first” or “second” may include at least one such feature either explicitly or implicitly. In addition, the meaning of “and/or” in the whole text is to include three concurrent solutions. For example, “A and/or B” includes an A solution, a B solution, and a solution in which A and B are satisfied at the same time.

The present disclosure proposes a solar panel gazebo or tent.

Referring to the figure, a solar panel gazebo or tent according to the present disclosure includes a canopy structure 3 including a plurality of sloping surfaces 9, a plurality of supporting poles 4 supporting the canopy structure 3, at least one eave structure 7 extending from a lower edge of one of the plurality of sloping surfaces 9; and at least one semi-flexible photovoltaic solar panel 1 mounted on the canopy structure 3 and/or the at least one eave structure 7. For example, the semi-flexible photovoltaic solar panel 1 can be mounted on the top surface of the canopy structure 3, on the top surface of the eave structure 7, or stretch across the top surface of the canopy structure 3 and the eave structure 7. The eave structure 7 is configured to provide additional area to mount the semi-flexible photovoltaic solar panel 1. The canopy structure 3 may have more than two sloping surfaces 9.

The at least one semi-flexible photovoltaic solar panel 1 is configured to collect solar energy. The semi-flexible photovoltaic solar panel 1 has the lightweight and durable properties, a high energy conversion efficiency to maximize power output. Unlike the rigid solar panel used in the existing tents, the photovoltaic solar panel 1 of the present disclosure is semi-flexible, such that the overall structural integrity and portability is enhanced. Specifically, the photovoltaic solar panel 1 of the present disclosure can be unfolded and folded along with the eave structure 7 without being separately disassembled.

The canopy structure 3 and the cave structure 7 are made of a durable, weather-resistant fabric that provides protection from the elements and supports the semi-flexible photovoltaic solar panel 1.

In some embodiments, the at least one eave structure 7 is foldable. The at least one eave structure 7 is provided with a supporting rod 8 configured to adjust an inclination of the at least one eave structure 7, wherein one end of the supporting rod 8 is connected to one supporting pole 4, and an other end of the supporting rod 8 is connected to the at least one eave structure 7. The length of the supporting rod 8 can be adjusted, such that the inclination angle of the eave structure 7 can be adjusted by adjusting the length of the supporting rod 8. Alternatively, the bottom surface of the eave structure 7 has a plurality of connection points to where the other end of the supporting rod 8 can be connected, such that the inclination angle of the eave structure 7 can also be adjusted.

In some embodiments, a shape of the at least one semi-flexible photovoltaic solar panel 1 is adaptable to contours of the canopy structure 3 and the at least one eave structure 7. In such a way, the top surfaces of the canopy structure 3 and the eave structure 7 can be mounted with as many semi-flexible photovoltaic solar panels 1 as possible. The shapes of the canopy structure 3 and the eave structure 7 may be triangle, rectangle or other polygons.

In some embodiments, each supporting pole 4 is provided with an adjustable mechanism 5 configured to adjust a length of the supporting pole 4. The adjustable mechanism 5 may be an adjustable joint. Each supporting pole 4 may include a plurality of pole sections connected by the adjustable joint. Alternatively, the supporting pole 4 may be in a telescopic structure. In such a way, a length of each supporting pole 4 can be adjusted, such that a height and inclination angle of the canopy structure 3 can be adjusted. The inclination angle of the eave structure 7 and the canopy structure 3 can be adjusted to adapt an incidence angle of the sunlight, such that the collection of solar energy can be maximized, thereby enhancing the overall energy output.

In some embodiments, each semi-flexible photovoltaic solar panel 1 is connected to a power storage system by a wiring 6 and an electrical connector 2 integrated with the semi-flexible photovoltaic solar panel 1. All components, including the semi-flexible photovoltaic solar panel 1, the electrical connector 2, and the wiring 6, are designed to be waterproof and weather-resistant, ensuring durability and reliable performance in all weather conditions.

In some embodiments, the plurality of supporting poles and the supporting rods are made of rust-resisting materials, such as aluminum or reinforced plastic. The canopy structure 3, eave structure 7, supporting pole 4 and supporting rod 8 are made of durable, weather-resistant materials to withstand outdoor conditions.

In some embodiments, each supporting pole 4 comprises at least two pole sections connected by an adjustable joint 5.

In some embodiments, the gazebo or tent is modular, wherein the at least one eave structure 7 and the pole sections are detachable. This feature enhances flexibility and adaptability, allowing for customized configurations and potential scalability.

In some embodiments, the gazebo or tent further comprises an integrated power storage system to store solar energy collected by the at least one semi-flexible photovoltaic solar panels. This feature ensures that the power can be provided even during cloudy days or at night, thereby enhancing the utility and appeal of the tent.

In some embodiments, the electrical connector and the wiring comprise a quick-connect system 10 to simplify setup and disassembly. The quick-connect system 10 may be fast-fit plugs or a push-in quick connectors. This feature improves ease of use and ensures that non-technical users can set up and take down the gazebo quickly.

In some embodiments, the gazebo or tent further comprises sensors to detect wind speed and weather conditions, automatically adjusting the at least one eave structure and the at least one semi-flexible photovoltaic solar panel. This feature enhances the durability and safety of the gazebo, ensuring it can withstand adverse weather conditions.

In some embodiments, the gazebo or tent further comprises an integrated lighting system powered by the collected solar energy. This feature increases the functionality of the gazebo, making it more appealing for evening or nighttime use.

In some embodiments, the gazebo or tent further comprises weighted bases or guy lines configured to increase stability of the gazebo or tent in windy conditions. This feature ensures the structure remains stable and secure even in windy conditions, enhancing safety.

Finally, it should be noted that the above embodiments are only intended to illustrate the technical solutions of the present disclosure, and not to limit them. Although the present disclosure has been described in detail with reference to the foregoing embodiments, those skilled in the art should understand that it is still possible to make modifications to the technical solutions recorded in the foregoing embodiments, or to make equivalent replacements for some of the technical features therein. These modifications or substitutions do not cause the essence of the technical solutions to depart from the spirit and scope of the technical solutions of the embodiments in the present disclosure.

What is claimed is:

1. A solar panel gazebo or tent comprising:
a canopy structure including a plurality of sloping surfaces,
a plurality of supporting poles supporting the canopy structure,
at least one eave structure connected to a lower edge of one of the plurality of sloping surfaces; and
at least one semi-flexible photovoltaic solar panel mounted on the canopy structure and/or the at least one eave structure; wherein
the at least one semi-flexible photovoltaic solar panel is configured to collect solar energy.

2. The solar panel gazebo or tent of claim 1, wherein the at least one eave structure is foldable.

3. The solar panel gazebo or tent of claim 2, wherein the at least one eave structure is provided with a supporting rod configured to adjust an inclination of the at least one eave structure, wherein one end of the supporting rod is connected to one supporting pole, and an other end of the supporting rod is connected to the at least one eave structure.

4. The solar panel gazebo or tent of claim 1, wherein a shape of the at least one semi-flexible photovoltaic solar panel is adaptable to contours of the canopy structure and the at least one eave structure.

5. The solar panel gazebo or tent of claim 1, wherein each supporting pole is provided with an adjustable mechanism configured to adjust a length of the supporting pole.

6. The solar panel gazebo or tent of claim 1, wherein each semi-flexible photovoltaic solar panel is connected to a power storage device by an electrical connector integrated with the semi-flexible photovoltaic solar panel and a wiring; the electrical connector and the wiring are waterproof.

7. The solar panel gazebo or tent of claim 2, wherein the plurality of supporting poles and the supporting rod are made of rust-resisting materials.

8. The solar panel gazebo or tent of claim 1, wherein each supporting pole comprises at least two pole sections connected by an adjustable joint.

9. The solar panel gazebo or tent of claim 8, wherein the gazebo or tent is modular, wherein the at least one eave structure and the pole sections are detachable.

10. The solar panel gazebo or tent of claim 1, further comprising an integrated power storage system to store solar energy collected by the at least one semi-flexible photovoltaic solar panels.

11. The solar panel gazebo or tent of claim 6, wherein the electrical connector and the wiring comprise a quick-connect system to simplify setup and disassembly.

12. The solar panel gazebo or tent of claim 1, further comprising sensors to detect wind speed and weather conditions, automatically adjusting the at least one eave structure and the at least one semi-flexible photovoltaic solar panel.

13. The solar panel gazebo or tent of claim 1, further comprising an integrated lighting system powered by the collected solar energy.

14. The solar panel gazebo or tent of claim 1, further comprising weighted bases or guy lines configured to increase stability of the gazebo or tent in windy conditions.
